(19) United States
(12) Patent Application Publication
(10) Pub. No.: US 2015/0160824 A1
(43) Pub. Date: Jun. 11, 2015

(54) SYSTEMS AND METHOD FOR MOBILE SOCIAL NETWORK INTERACTIONS

(71) Applicant: Cubed, Inc., Las Vegas, NV (US)

(72) Inventor: Stephen White, Las Vegas, NV (US)

(21) Appl. No.: 14/538,980

(22) Filed: Nov. 12, 2014

Related U.S. Application Data
(63) Continuation of application No. 14/178,367, filed on Feb. 12, 2014.
(60) Provisional application No. 61/903,180, filed on Nov. 12, 2013.

(51) Int. Cl. G06F 3/0481; G06F 3/0484

(52) U.S. Cl. CPC G06F 3/04815; G06F 3/04847

(57) ABSTRACT

The present invention relates to the control and distribution of information and media content, and, more particularly, to an engine, system and method of providing interactive content delivery management.

### CROSS-REFERENCE TO RELATED APPLICATION

This present application is a continuation of U.S. patent application Ser. No. 14/178,367, filed Feb. 12, 2014, entitled Computer-Implemented Virtual Object for Managing Digital Content, and claims priority to U.S. Provisional Patent Application No. 61/903,180, filed Nov. 12, 2013, entitled Systems and Method for Mobile Social Network Interactions, the entirety of which is incorporated herein by reference as if set forth herein in its entirety.

### BACKGROUND

1. Field of the Invention

The present invention relates to the control and distribution of information and media content, and, more particularly, to an engine, system and method of providing interactive content delivery management.

2. Background of the Invention

Although there are many forms of communication by which information and other content may be managed and distributed, none offer easy access for a consumer of goods and/or services to receive desired information. Similarly, present day system fail to provide a provider of content robust and meaningful contact with a particular person or provides the ability to individualize and tailor information and advertisement delivery.

Thus, there exists a need for an engine, system and method that provides an easy-to-use, cloud-based interactive contact management vehicle.

### SUMMARY

The present invention includes at least a computer-implemented engine, system and method for managing and providing content to at lest one end user.

### BRIEF DESCRIPTION OF THE DRAWINGS

The accompanying drawings are included to provide a further understanding of the disclosed embodiments. In the drawings, like numerals represent like elements, and:

FIG. 1 illustrates an aspect of an exemplary embodiment of the present invention;

FIG. 2 illustrates an aspect of an exemplary embodiment of the present invention;

FIG. 3 illustrates an aspect of an exemplary embodiment of the present invention;

FIG. 4 illustrates an aspect of an exemplary embodiment of the present invention;

FIG. 5 illustrates an aspect of an exemplary embodiment of the present invention;

FIG. 6 illustrates an aspect of an exemplary embodiment of the present invention;

FIG. 7 illustrates an aspect of an exemplary embodiment of the present invention;

FIG. 8 illustrates an aspect of an exemplary embodiment of the present invention;

FIG. 9 illustrates an aspect of an exemplary embodiment of the present invention; and

FIG. 10 illustrates an aspect of an exemplary embodiment of the present invention.

### DETAILED DESCRIPTION

Computer-implemented platforms, engines, systems and methods of use are disclosed that provide networked access to a plurality of types of digital content, including but not limited to video, audio, metadata, interactive and document content, and that track, deliver manipulate, transform and report the accessed content. Described embodiments of these platforms, engines, systems and methods are intended to be exemplary and not limiting. As such, it is contemplated that the herein described systems and methods can be adapted to provide many types of cloud-based valuations, scoring, marketplaces, and the like, and can be extended to provide enhancements and/or additions to the exemplary platforms, engines, systems and methods described. The invention is thus intended to include all such extensions. Reference will now be made in detail to various exemplary and illustrative embodiments of the present invention.

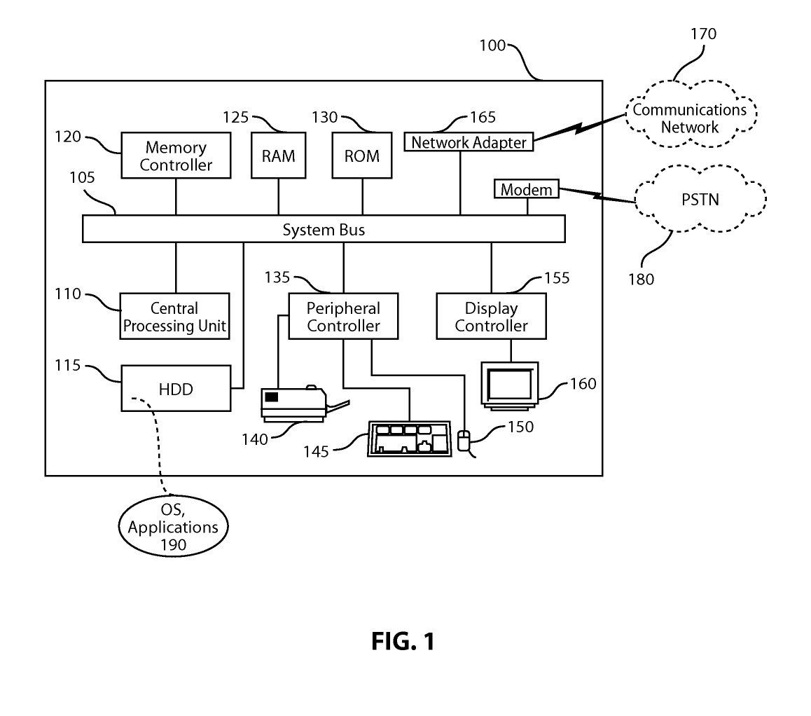

FIG. 1 depicts an exemplary computing system 100 for use in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output and/or presentation generated by or at the request of computing system 100. Such visual output may include text, graphics, animated graphics, and/or video, for example. Display 160 may be implemented with a CRT-based video display, an LCD-based flat-panel display, gas plasma-based flat-panel display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet. Communications network 170 may provide user access for computing system 100 with means of communicating and transferring software and information electronically. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

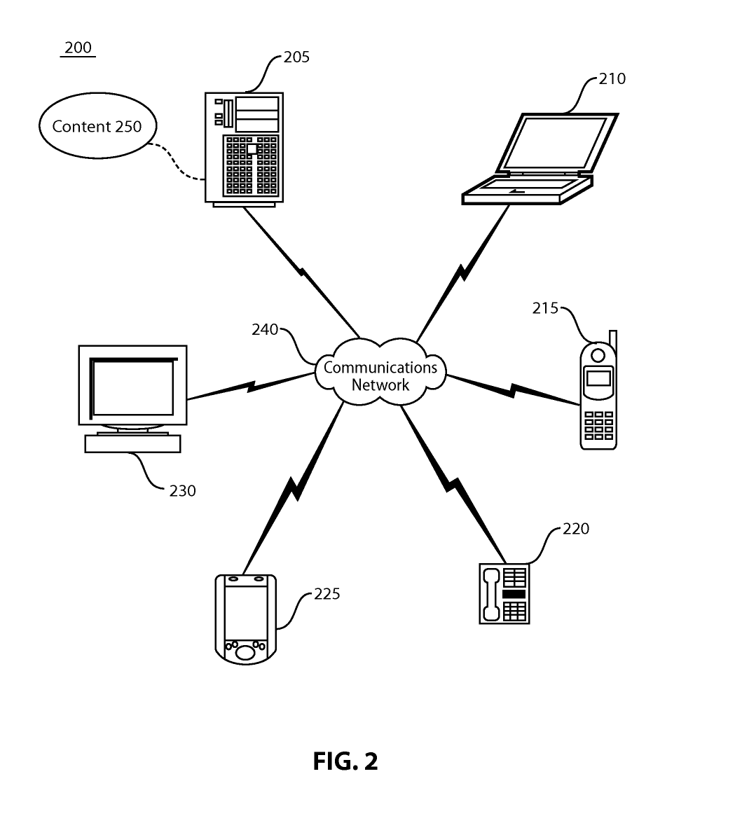

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or the like, to interact with server 205.

The present invention may provide a widget which may allow for the portability of content between devices held or operated by a user. Such a widget may come in a particular shape so as to provide segmentation of the provided content and make such content more easily accessible and viewable by the user. Such a shape may preferably be a cube, but may also be in the form of a segmented sphere, a diamond, a cylinder, a pyramid and/or any other shape desired and/or considered practical by those skilled in the art. Although the widget may take on any number of forms, and may take on different shapes as desired by the user, as discussed in the present application, the widget will be described as a “cube” herein throughout.

The cube may be viewed as an object within a graphical user interface (GUI), and may be viewed in any orientation. The cube may, for example, be manipulated in any direction by the user to more easily access the information contained therein and/or to view the content contained within the cube. The visualization of the information contained within the cube may be projected on one or more sides of the cube. For example, a user may wish to upload one or more pictures which may be viewed and/or accessed from the cube. The user may choose to load content to one particular side of the cube or assign one particular side with content information related to, for example, pictures and have the content information and/or pictures either viewable and/or accessible through at least one side of the cube. Thus, by activating a particular side or designated portion of the cube, the user may interact with a portion of the cube, e.g., view a slide show of the loaded pictures. By way of continuing example, the user may also access the pictures uploaded to the cube by clicking or otherwise activating the picture side of the cube. As would be appreciated by those skilled in the art, the uploaded images may be cropped and/or manipulated to best fit the size and shape of the cube and to provide the user with the necessary editing capabilities to create the desire outcome.

Of course, content to the cube is not limited to images only. Any electronically based content and/or media may be associated with the cube and/or viewable through the cube. For example, video, audio, RSS feeds, email correspondence, web pages, URL links, social media access, such as, for example, Facebook and Twitter feeds, documents, file uploads, FTPs, and the like. By way of non-limiting example only, a user may associate a blog with one portion of the cube. Such an association may allow for a real time update and interaction with the blog by the user through the cube. Such an association may allow the user to access and/or interact with the blog through having access only to the cube and without having direct access to the blog. In this way, a user need only avail themselves of access to the cube rather than access to all the content otherwise associated with the cube.

For example, images uploaded to the cube may have originated from a desktop environment of the user and may be inaccessible by the user outside of direct contact or access to the desktop environment. Therefore, if the user has access to the cube via some other means of interaction, such as, through a smart phone device, the user may still have the ability to access the photos on the cube. As would be appreciated by those skilled in the art, the content associated with the cube may be uploaded into a cloud computing environment which may offer dedicated storage access and/or capabilities for the cube or the cube may simply access content through addressing the content directly. Content not otherwise uploaded into storage directly associated with the cube may be accessed through a mobile device may link directly into the desktop environment where the pictures are located in order to more fully access or view the desired media.

As discussed herein, the cube and/or widget may be imported and/or resident on any device desired by the user. For example, the cube may be resident on a user's desktop environment as an icon and/or a free embodied feature which may be continually viewed and/or accessed by the user regardless of other desktop functionality. Being associated with a particular cube having particular content, the user may call the cube to other devices such as, for example, a smart phone. By way of further example, the cube may be called at any electronic device such as, for example, a kiosk which may be placed in a shopping mall, a retail store, a city government building, a parking garage, and/or any other place providing access to the public. In this way, the cube offers the user the ability to access, deliver, and port information and content to any location for which the user has possession of an electronic device.

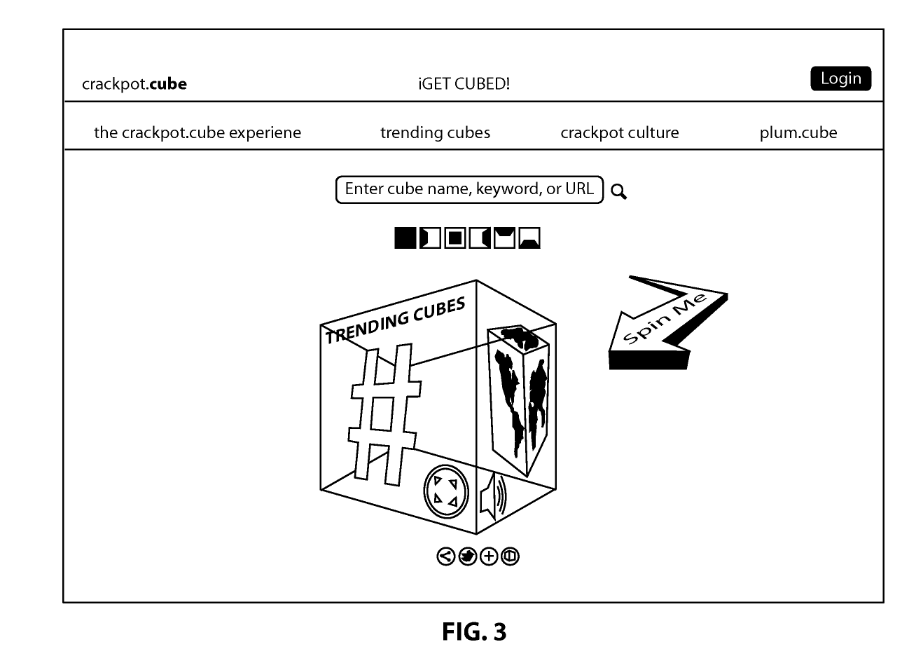

As illustrated in FIG. 3, an embodiment of the cube may allow for a semi-transparent graphical representation. In such an embodiment, the user may not only be able to visually identify content present on various sides of the cube, but may also visually discern what information under a content the cube may be otherwise blocking such as, for example, features of a desktop and/or mobile interface. As illustrated in FIG. 3, the cube has included thereon audio on at least one side of the cube. Access to the audio may be presented to the user in a variety of ways, but may be provided through interaction with an icon denoting an audio file as illustrated. Similarly, and as discussed hereinabove, although content may be cropped and/or edited to be more visually accommodated within a side of the cube, functionality may be provided to expand within the cube or the cube itself the information contained within the cube. For example, an expansion icon as illustrated on the left side of the cube in FIG. 3 may be provided to allow for manipulation of that particular side of the cube. In this way, a user may interact with a particular side of the cube without leaving the cube environment.

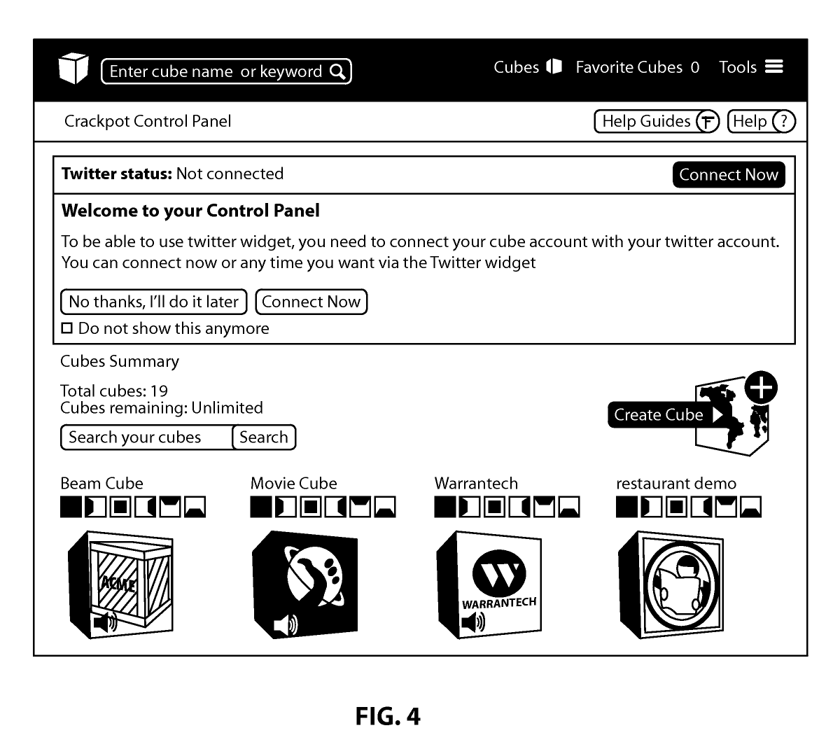

As illustrated in FIG. 4, the present invention may provide a GUI which may allow for the creation of one or more cubes for each user. For example, a user may wish to build a cube devoted to a particular subject and/or topic which may allow a user to better organize his or her access to content. Thus, such a particular cube may be devoted to social media which may, for example, include a cube having a side devoted to a Twitter® feed, a side devoted to a Facebook® feed, a side devoted to Google® Circles, a side devoted to YouTube® videos, a side devoted to a picture album, a side devoted to text messaging, a side devoted to email, and/or a side devoted to voice calls. Having a cube devoted to a particular subject and/or topic, may allow a user to choose how many cubes to access at a particular time and/or how many cubes may be available between devices controlled by the user.

Continuing with the example of a cube devoted to social media, the at least one side of the cube devoted to a photo album may include individual photos uploaded by the user to the cube, photos and/or images gathered from particular sites, and/or from other cube users or designated users of other social networks. By way of non-limiting example only, a user may associate the photo album on a mobile device such that images captured by the mobile device are automatically provided to the designated portion of the cube. Similarly, images captured by the mobile device may be sent manually and/or by rule to the cube. Such a rule which may be set by the user may include variable such as time of day, location, logged in user, and/or content of the image.

As discussed herein, the social networking cube example may further include a portion dedicated to communication with other cubes and/or other platforms such as, for example, Skype, text messaging, instant messaging, email, Twitter, and/or any other form of instant communication. For example, a communication channel associated with the cube may be left open and/or always logged in such that the user may have relative instant access to such a channel. By way of further example, a user may associate with at least one side of the cube a communication tool such as, for example, Skype®, which may be left open such that the user may interact with that portion of the cube to instantaneously access Skype and/or may be alerted either visually and/or audibly to activity within Skype through the open channel on the cube. Furthermore, as will be discussed in more detail herein, because the cube may be shared by the user with other third parties, communication channels, for example, may be shared across multiple devices with multiple users.

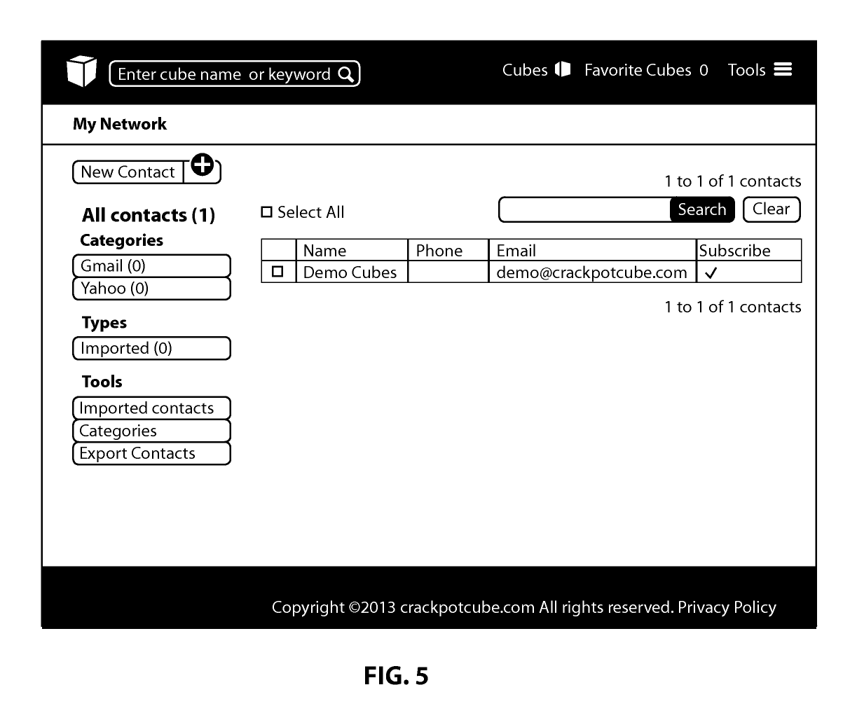

As illustrated in FIG. 5, the present invention may provide the user the ability to associate the cube with specific contact information such as from an email, for example, and may allow a user to provide a description and/or name for each cube the user may create. The user may also have the ability to quickly share a created cube with one or more third parties and may, for example, choose a new contact from contacts which may exist either within the interface provided through the present invention and/or accessed from such programs such as Outlook, for example.

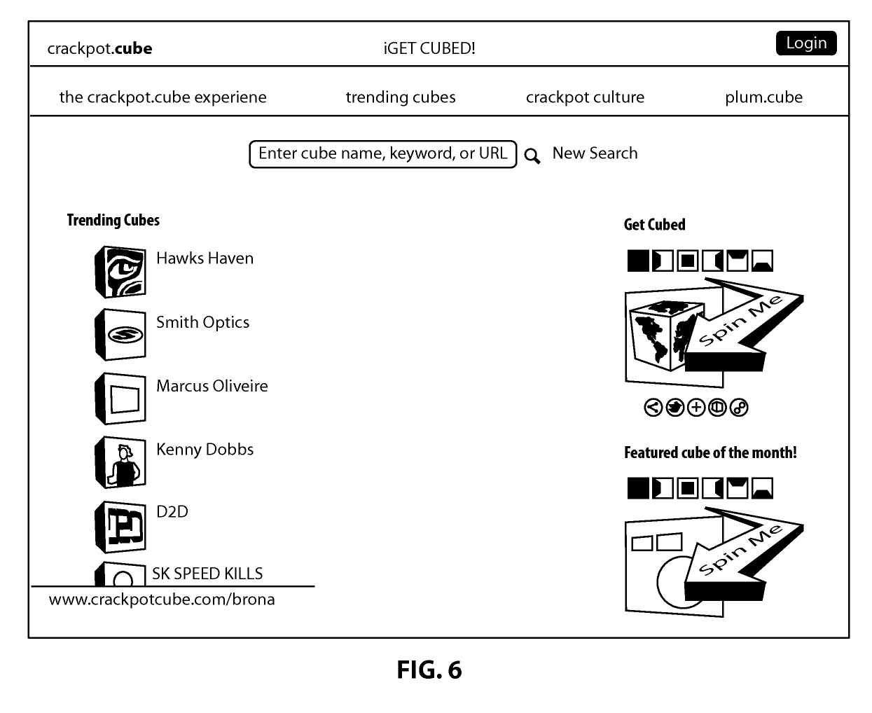

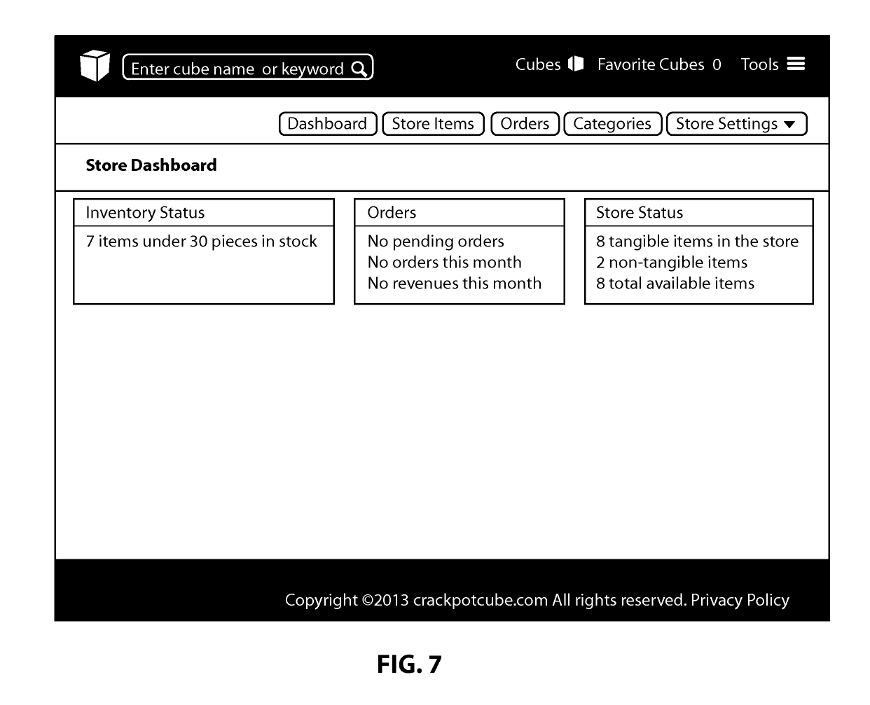

As illustrated in FIG. 6, cubes created by third parties may be available to any user and may be associated with each user as desired. For example, the GUI of the present invention may provide a list of trending cubes and/or cubes determined to be of interest to the user which may include cubes devoted to particular sporting teams, particular types of products, and/or various aggregations of information, such as, for example, news feeds. By way of example, a news cube may be imported by the user and may include feeds for the major network news outlets and may include such things as live video feeds and/or news alerts. Although many such third party cubes may be provided at no cost, some cubes may be provided at a cost to the user. Such costs may take the form of subscription costs and/or one time fees. Similarly, a cube may be provided wherein a particular side of the cube offers something for purchase to the user. Such as, for example, a service and/or good. As illustrated in FIG. 7, the present invention may provide a dashboard allowing the user to manage the purchase of cubes and/or discrete services and/or of goods.

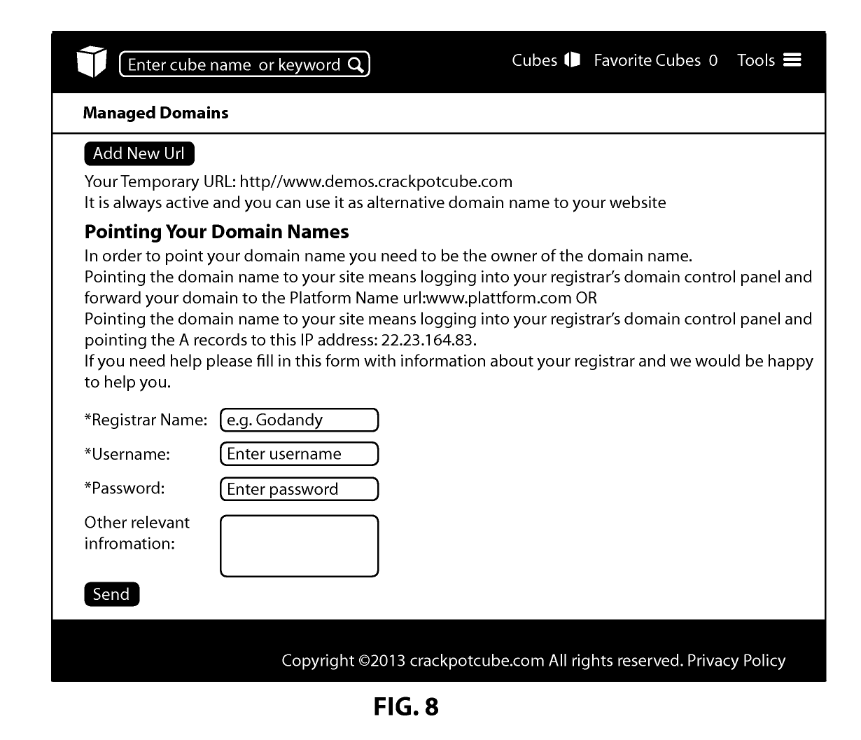

As discussed herein and as illustrated in FIG. 8, a user may associate a specific domain with a particular side of the cube. Such pointing to a particular domain may provide to the cube direct access to the domain by the user through simple interaction such as, for example, clicking on that side of the cube, it may also allow the content or at least a portion of the content resident at the domain to be pushed to the cube. The pushing of content may allow for such things as enhanced communications with the user of the cube and/or targeted advertising to the user of the cube by the owner of the domain. In an embodiment of the present invention, an advertisement may be delivered through a domain associated with at least one side of the cube based upon the users attributes, the user's interactions with the cube, and/or environmental factors such as, for example, the time of day.

For example, a user may have associated with at least one side of a cube a news outlet such as the New York Times. The New York Times, in turn, may deliver as to the user based on user characteristics, which may include, for example, demographics, interaction history with the New York Times and/or other portions of the cube, and/or location of the user. Thus, if the user is actively engaged with the New York Times through the cube, and/or has a past history of interaction with the New York Times through the cube and is demographically targeted for a particular ad, that ad may be delivered by the New York Times to the face of the cube during, for example, periods of non-interaction with the New York Times side of the cube. In a similar fashion, an ad from in the New York Times may be delivered to the New York Times side of the cube when the user is interacting with at least one other side of the cube. Thus, alerting the New York Times that the user is visually attuned to the cube and may be more greatly impacted by the delivered ad.

Such an ad delivery may take any number of forms as appreciated by those skilled in the art, and may occur for a period of time such as, for example, five seconds. The delivery of advertisements may also be optimized such that the user has a greater chance of viewing the ad delivered to the cube. In this way, for example, an ad delivered by the New York Times may be delivered to the side of the cube most visually exposed to the user even if that side of the cube is not the side of the cube designated by the user for access to the New York Times. In such an instance, the ad delivered by the New York Times may take priority over the content being viewed by the user on the at least one most prominent side.

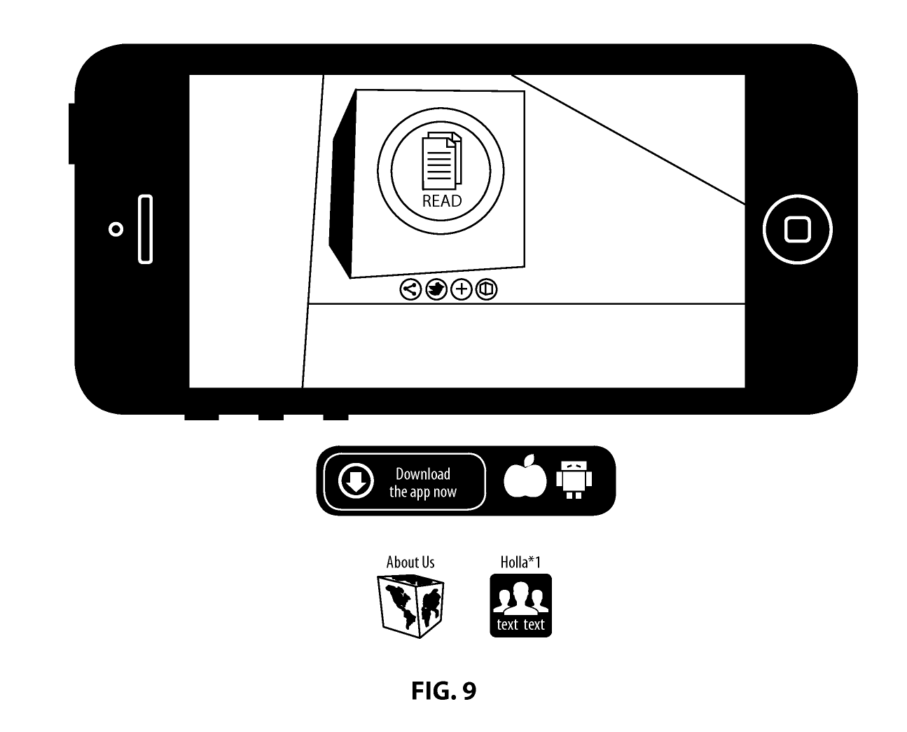

As illustrated in FIG. 9, for example, the cube may generally have at least two sides exposed to view by the user. In the embodiment illustrated in FIG. 9, the cube is an overlay on video content being viewed on a mobile device by the user. Although a user may wish to minimize or hide the cube behind content being actively viewed, the cube may, as illustrated, be actively assessable over the primary content visible on the device.

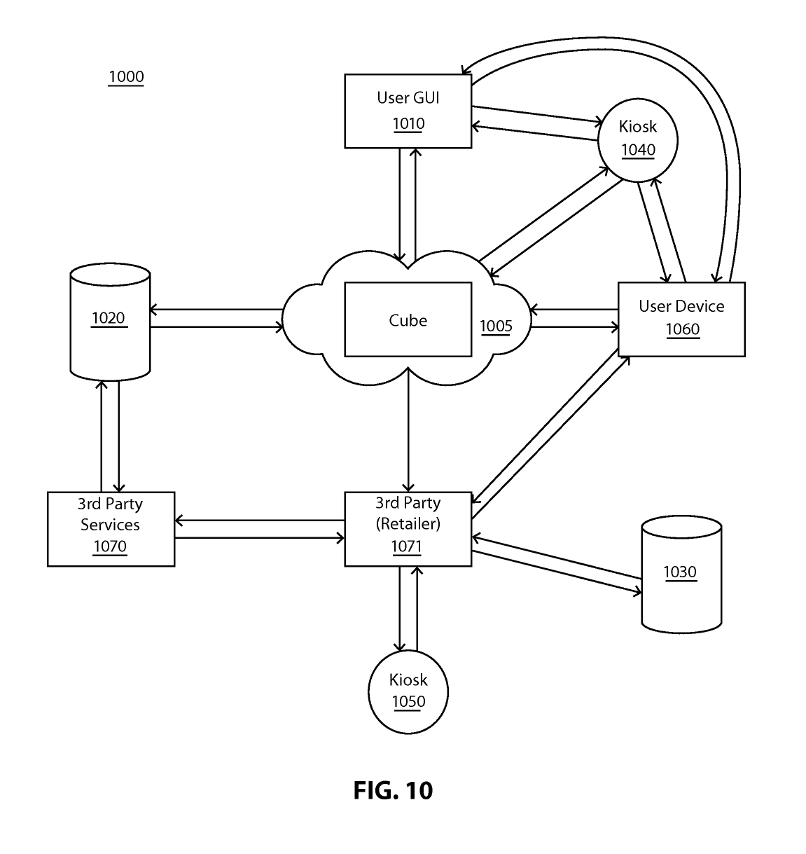

As illustrated in FIG. 10, System 1000 may include at least one cube within at least one cloud environment 10005 which may communicatively allow the cube to be viewed by the user in many forms and in many locations such as, for example, Kiosk 1040, user device 1060, Kiosk 1050, and/or through user GUI 1010, for example. The cubed cloud environment 10005 may have associated with it at least one database 1020 which may allow for the storage of cube content and other points of information such as, for example, URL's, passwords, and the cube interaction history. Database 1020 may also include user characteristics and statistics of use of the cube for access by the user and/or third parties which may use such user statistics to deliver, for example, advertising and/or particular cubes of information.

Kiosk 1050, for example, may be provided at a third party retailer wherein information may be provided about products and/or services offered by or through a third party retailer. By way of example, a large home improvement store may have within its walls at least one Kiosk with access to at least one cube provided by at least one manufacturer. The cube, for example, may be provided by a manufacturer of small power tools and may be provided for access by a user to gain product information and/or support. For example, a customer in the store may access the cube offered by the Kiosk which may in turn have embedded thereon a video demonstrating use of at least one produce offered by the vendor, and/or access to social media and/or live customer service whereby at least one side of the cube includes a portal to a live remote customer service representative. The presented cube may offer not only instant access to information and customer service help, but may also provide contact information for the vendor and/or a coupon for one or more products offered by the vendor and for use within the store for purchase of such a good.

By way of non-limiting example only, a user interacting with a Kiosk may be seeking information regarding a particular power saw, and may seek direct advice from a customer service representative which may allow the user to fully discuss any and all questions regarding the potential purchase of the power tool. Upon completion of that conversation, the representative may offer to the customer a coupon for the purchase of the power saw for which the consumer inquired, and may provide the coupon via the cube. The provided coupon may be printed at the Kiosk or may be imported to a cube already existing on the user's portable device. The coupon and/or cube may be passed to the customer by methods known to those skilled in the art, such as, for example, via NFC, Bluetooth, QR code, and the like.

A customer may choose to receive a coupon or additional information via the acceptance of a cube from the manufacturer or through more conventional means, such as, for example, a text or email message. In addition to offering discounted information, the consumer may be informed about where in the store the item exists and/or where possible accessories are available. Even without the Kiosk, similar results may be obtained by allowing a consumer to link to at least one cube via a mobile device. For example, a QR code or other addressing technique may be employed at the point of purchase and/or at the point of display for the desired item. A consumer interested in more information about a power saw, for example, may choose to import a cube to their device which has information regarding at least the power saw. The newly accessed cube may include the same functionality as discussed above and may additionally take advantage of location-based information to provide the consumer with addition product information and/or advertisements targeted to the consumer.

Although a cube may be deleted by the user, the addition of a manufacturer's cube and/or the association of such information to a portion of an existing cube, may allow for the continued tracking of a consumer's behavior which may allow for the optimizing of ad and/or coupon delivery. For example, a particular manufacturer cube focused on a particular model of automobile may allow the originator of the cube, in the case the automobile manufacturer, to track the holder of the cube to determine, for example, what other car dealerships are being visited. Thus, the automobile manufacturer may determine which other types of cars the prospective buyer is considering and may deliver to the prospective consumer advertisements which may be focused on product comparisons, for example.

As will be appreciated by one skilled in the art, the delivery of ads and the acceptance of other information, may be controlled by the creator and/or user of the cube. Similarly, creators of a cube may have remote access to a cube and the ability change or alter cube through platforms such as, for example, HTML5.

Those of skill in the art will appreciate that the herein described systems and methods may be subject to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A tangible computer-readable medium storing computer-executable instructions for organizing a plurality of files, wherein the computer-executable instructions, when executed on a user device, cause the user device to perform steps comprising:
rendering and presenting on a display of the user device a virtual three dimensional object having a plurality of delineated surfaces;
receiving a user input by the user device to manipulate the virtual object to present a select one of the surfaces more prominently on the display than the non-selected surfaces of the virtual object;
receiving a user input by the user computing device as a choosing of a graphical element disposed on the selected surface, and
performing a predetermined task responsive to the choosing of the graphical element.

2. The computer-readable medium of claim 1, wherein the virtual object is a virtual cube.

3. The computer-readable medium of claim 2, wherein the selected face is a square face of the cube presented in the foreground.

4. The computer-readable medium of claim 3, wherein the selected face has disposed thereon at least one graphical element linked to a file or to executable code.

5. The computer-readable medium of claim 4, wherein the graphical element is linked to a file with a name containing a file extension that, when the graphical element is chosen by a user, is used to launch a predetermined application (app) and open the file.

6. The computer-readable medium of claim 4, wherein the graphical element is linked to computer code that is executed responsive to the graphical element being chosen by a user.

7. The computer-readable medium of claim 4, wherein the file or computer code is stored on the user device.

8. The computer-readable medium of claim 4, wherein the file or computer code is stored remotely from the user device and is accessed by the user device over a network.

9. A user interface enabling a user to create a virtual three dimensional object for organizing a plurality of files, the interface comprising:
a first input mechanism for accepting user input for setting at least one characteristic of a virtual three dimensional object having a plurality of delineated surfaces;
a second input mechanism for accepting user input for choosing at least one graphical element for placement on at least a select one of the delineated surfaces, and
a third input mechanism for accepting user input for setting at least one characteristic of the graphical element placed on the select surface.

10. The user interface of claim 9 wherein the first input mechanism is for choosing one of a plurality of available three dimensional shapes.

11. The user interface of claim 10, wherein the chosen shape is a cube.

12. The user interface of claim 9, wherein the graphical elements include a plurality of elements, each of which is one of an image, a design, and an icon.

13. The user interface of claim 9, wherein the characteristic of the graphical element placed on the select surface includes a link to a file or executable code.

14. A computing device with an associated display device on which is presented a virtual three dimensional object for organizing a plurality of files, said-computing device comprising:
a tangible computing processor;
a network interface communicatively coupled to the processor and operative to communicatively couple the processor to a tangible data communication network; and
a non-transitory computer-readable data storage device communicatively coupled to the processor and having stored thereon computer readable instructions which, when executed by the processor, cause the computer to perform steps including:
presenting a virtual three dimensional object on the display device, the object comprising a plurality of delineated surfaces;
manipulating, responsive to a user input, the virtual object to present one of the surfaces more prominently than the others as a selecting of one of the surfaces;
receiving a user input as a choosing of a graphical element disposed on the selected surface, and
performing a predetermined task responsive to the choosing of the graphical element.

15. The computing device of claim 14, wherein the virtual object is a virtual cube.

16. The computing device of claim 15, wherein the selected face is a square face of the cube presented in the foreground.

17. The computing device of claim 16, wherein the selected face has disposed thereon at least one graphical element linked to a file or to executable code.

18. The computing device of claim 17, wherein the graphical element is linked to a file with a name containing a file extension that, when the graphical element is chosen by a user, is used to launch a predetermined application (app) and open the file.

19. The computing device of claim 17, wherein the graphical element is linked to computer code that is executed responsive to the graphical element being chosen by a user.

20. The computing device of claim 17, wherein the file or computer code is stored on the user device.

21. The computing device of claim 17, wherein the file or computer code is stored remotely from the user device and is accessed by the user device over a network.
